(19) United States
(12) Patent Application Publication
(10) Pub. No.: US 2010/0150803 A1
(43) Pub. Date: Jun. 17, 2010

(54) METHOD FOR CAPTURING CARBON DIOXIDE

(76) Inventor: Chien-Feng Lin, Hsinchu City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/334,020

(22) Filed: Dec. 12, 2008

(51) Int. Cl. B01D 53/62

(52) U.S. Cl. 423/224

(57) ABSTRACT

A method for capturing carbon dioxide has been disclosed in the invention, comprising the steps of: (1) electrolyzing a saturated salt solution so as to obtain sodium hydroxide; (2) adding the sodium hydroxide into a seawater solution, so as to allow magnesium chloride and calcium chloride in the seawater to be converted into magnesium hydroxide and calcium hydroxide; (3) bringing carbon dioxide into a water solution having magnesium hydroxide and calcium hydroxide, so as to convert them into magnesium carbonate and calcium carbonate. The method allows for the capture of carbon dioxide in an effective, fast and safe manner, which reduces the amount of atmospheric carbon dioxide, and cuts down carbon dioxide emissions consequently.

### FIELD OF THE INVENTION

The invention relates to a capturing method for reducing carbon dioxide (CO₂) emissions, and more particularly to a method for capturing carbon dioxide (CO₂) released from industrial applications by using chemical reactions.

### DESCRIPTION OF PRIOR ART

Commonly, there are a variety of chemical substances existing in the atmospheric environment, which do not present problems to the ecological environment under normal circumstances and concentrations. But as the pace of industrialization advances continuously, the use of all types of industrial machinery and transportation leads to the excessive emissions of more and more chemical substances. More importantly, the excessive emissions of all types of chemicals lead to air pollution eventually.

Many types of air pollutants exist currently, and the most common and monitored air pollutants include: carbon dioxide (CO₂), carbon monoxide (CO), sulfur dioxide (SO₂), nitrogen oxides (NOₓ), suspended particulates, Ozone (O₃), and volatile organic compounds (VOCs).

The air pollution poses both direct and indirect influences to humans and the environment, and the direct influences include: damages to the health of humans, animals, and plants living in the ecosphere; while the indirect influences include: the environmental problems caused by acid rain and global warming.

In Earth's atmosphere, the major “greenhouse gases” include carbon dioxide (CO₂), methane (CH₄), and nitrogen dioxide (NO₂). The so-called “greenhouse gases” refer to those atmospheric gases that contribute to temperature increases of the Earth, and the increases in the Earth's temperature is the most important environmental issue at the moment, in which carbon dioxide (CO₂) bears the most significant influence on global warming, and the primary factor that contributes to the problem of global warming is the increases of atmospheric greenhouse gases. Therefore, the most urgent issue faced by the current environmentalists is about how to reduce the amount of atmospheric carbon dioxide (CO₂), and countries around the world are diligently working on reducing carbon dioxide (CO₂) emissions now.

Under the present condition of being unable to refrain from using fossil fuels, it is necessary to enhance the efficiency of utilizing fossil fuels, and complement it with the technologies of capturing, storing, and re-using carbon dioxide, which is deemed as the most effective way for slowing down the process of global warming, so that the humans can continue to take advantage of lowly priced fuels, and gradually make a transition to using new sources of fuels in the future.

In addition, the “storage of carbon dioxide” refers to the storage of carbon dioxide in natural or artificial “containers” specifically, and the major aim is to seal and store carbon dioxide for more than a century by using physical, chemical, and biochemical mechanisms. Forests, ocean, geological strata, artificial storage tanks, and chemical reactors can all be used as the “containers” for storing carbon dioxide.

The methods of storing carbon dioxide “on a large scale” proposed internationally can be further divided into geologic storage, sub-surface storage, and ocean storage. Currently, the operational costs for capturing, transporting, and storing a metric ton of carbon dioxide are USD$5-115, USD$0.4-3.2 for every one hundred kilometers, and USD$0.5-100; respectively. In addition, in a power station running the latest technology of Integrated Gasification Combined Cycles (IGCC), the cost for capturing each metric ton of carbon dioxide is approximately USD$13-37, while the cost for geologically storing each metric ton of carbon dioxide is approximately USD$0.5-8, while the cost for storing each metric ton of carbon dioxide in the ocean is approximately USD$5-30, and the cost for storing each metric ton of carbon dioxide within sub-surface is approximately USD$50-100. Please refer to the article “The Storage of Carbon Dioxide” by Cheng-Guo Lin, from the journal of “Science Development”, May 2007, 413, pp. 28-33.

The aforesaid technology of storing carbon dioxide still faces the problem of determining whether there is any proper storage “containers” available at the moment, and the technology is still not sufficiently mature for actual applications, due to the fact that issues related to stability and following monitoring thereof are not fully resolved yet.

### SUMMARY OF THE INVENTION

In light of the aforesaid disadvantages existing in the conventional technologies for storing carbon dioxide, the inventor of the invention has realized the insufficiency thereof, and subsequently proposed a method for capturing carbon dioxide from continuous research and personal experience in the industry, which aims to provide a method for capturing a large amount of carbon dioxide in a fast and safe manner, thereby alleviating the problem of rising carbon dioxide concentration globally.

A method for capturing carbon dioxide is disclosed in the invention, comprising the steps of:
(1) electrolyzing a saturated salt solution so as to obtain sodium hydroxide, which has a chemical reaction formula of:

2NaCl+2H₂O→2NaOH+Cl₂+H₂;
(2) adding the sodium hydroxide into a seawater solution, so as to allow magnesium chloride and calcium chloride in the seawater to be converted into magnesium hydroxide and calcium hydroxide, which has chemical reaction formulas of:

MgCl₂+2NaOH→Mg(OH)₂+2NaCl

CaCl₂+2NaOH→Ca(OH)₂+2NaCl;
(3) bringing carbon dioxide into a water solution having magnesium hydroxide and calcium hydroxide, so as to convert them into magnesium carbonate and calcium carbonate, which has chemical reaction formulas of:

Mg(OH)₂+CO₂→MgCO₃+H₂O

Ca(OH)₂+CO₂→CaCO₃+H₂O

In the aforesaid method for capturing carbon dioxide, the saturated salt solution used in the step (1) is a brine having high concentration of salt, and is preferably a waste product resulted from seawater desalination.

In addition, the sodium hydroxide of the step (1) can be a by-product of chlorine gas resulted from electrolyzing a saturated salt solution.

### BRIEF DESCRIPTION OF DRAWINGS

FIG. 1 is a schematic view that shows the electrolysis of a saturated salt solution (brine) according to the invention.

FIG. 2 is a schematic view that shows the preparation of magnesium hydroxide and calcium hydroxide, and the capture of carbon dioxide according to the invention.

### DETAILED DESCRIPTION OF PREFERRED EMBODIMENTS

The aforesaid objectives, characteristics, and advantages of the present invention will be more clearly understood when considered in conjunction with the accompanying embodiments and drawings, in which:

A method for capturing carbon dioxide has been disclosed in the invention, which mainly comprises three steps: (1) electrolyzing a saturated salt solution so as to obtain sodium hydroxide; (2) adding the sodium hydroxide into a seawater solution, so as to allow magnesium chloride and calcium chloride in the seawater to be converted into magnesium hydroxide and calcium hydroxide; (3) bringing carbon dioxide into a water solution having magnesium hydroxide and calcium hydroxide, so as to convert them into magnesium carbonate and calcium carbonate.

In the preparation of sodium hydroxide (NaOH) therein, the sodium hydroxide can be a by-product from an industrial process for generating chlorine gas, and the most common method for achieving this is to electrolyze a saturated salt solution until all of the chlorine elements are converted into and escape as chlorine gas, which in turn leaves sodium hydroxide as the only dissolved substance in the solution; the described reaction has a chemical reaction formula shown below:

2NaCl+2H₂O→2NaOH+Cl₂+H₂

After electrolyzing the saturated salt solution, the reactant, sodium hydroxide, required for carrying out the method for capturing carbon dioxide according to the invention can be obtained subsequently; wherein the saturated salt solution can be obtained from a waste product resulted from seawater desalination.

Previously, the process of seawater desalination is mainly employed in the arid Middle East region, but as the development of industrialization and commercial activities pick up rapidly, and compounded by the factor of increasing global populations, the demand for freshwater has intensified worldwide. As countries around the world realize it is more and more difficult to obtain sufficient freshwater from current sources of water, the search for new sources of water has strengthened, and the technology of seawater desalination is the method most commonly used by the developed countries for obtaining freshwater.

The ocean takes up the largest surface area on the Earth, and this makes the ocean the largest reservoir and the most stable source of water available on the Earth. In addition, the total amount of water held in the ocean does not fluctuate significantly or evaporate during all seasons and under all weather conditions. Combining the aforesaid factor together with the recent improvements in the technology of seawater desalination, it is plausible to suggest that seawater could be utilized as a source of high-quality water for the humans.

Seawater desalination is a technology for processing water, and the underlying principle thereof is to utilize energy for separating salt water into two different parts; one of which is freshwater that contains low concentration of salt, and the other is a brine that contains high concentration of salt, which is further desalinated. Currently, some technologies of desalination are still being experimented, and two of the most commonly used methods of desalination are reverse osmosis desalination (which occupies 47.2% of global desalination capacity) and multi-stage flash desalination (which occupies 36.5% of global desalination capacity).

The method for capturing carbon dioxide of the invention can utilize brines, which are the waste products resulted from seawater desalination; for preparing sodium hydroxide, and this makes use of wastes effectively, which consequently makes the most out of the global resources.

During the preparation of sodium hydroxide, chlorine gas is produced simultaneously, and can be widely used in the production of polyvinyl chloride —(CH₂CHCl)n-. Since polyvinyl chloride is prepared from using ethylene, chlorine, and catalysts and has properties including fire- and heat-resistance, this means polyvinyl chloride can be widely employed in a variety of products related to different industries; such as wiring and cables, optic fiber cables, shoes, handbags, bags, ornaments, signs and billboards, house renovation works, furniture, trinkets, rollers, tubes, toys, curtains, roller doors, auxiliary medical equipment, gloves, wrappings for foods, and fashion wears.

Subsequently, the sodium hydroxide is added into a seawater solution, so as to allow magnesium chloride and calcium chloride in the seawater to be converted into magnesium hydroxide and calcium hydroxide, the reaction has chemical reaction formulas shown below:

MgCl₂+2NaOH→Mg(OH)₂+2NaCl

CaCl₂+2NaOH→Ca(OH)₂+2NaCl

The elemental composition of seawater on the Earth is shown in Table 1 below:

TABLE 1
The elemental composition of seawater on the Earth.

| Name of the element | Percentage (mass percent) |
|---|---|
| Oxygen | 85.7 |
| Hydrogen | 10.8 |
| Chlorine | 1.9 |
| Sodium | 1.05 |
| Magnesium | 0.1350 |
| Sulfur | 0.0885 |
| Calcium | 0.04 |
| Potassium | 0.0380 |
| Bromine | 0.0065 |
| Carbon | 0.0026 |

The elements that include calcium and magnesium can be found in seawater naturally, and exist mainly in the form of magnesium chloride and calcium chloride in seawater. By allowing magnesium chloride and calcium chloride to react with sodium hydroxide, reactants including magnesium hydroxide and calcium hydroxide that are required for the next step of the method can be obtained, thereby effectively reducing costs for obtaining the raw materials of the method for capturing carbon dioxide according to the invention, and making efficient use of the natural resources available on the Earth.

After obtaining magnesium hydroxide and calcium hydroxide from the aforesaid reaction, the industrially released carbon dioxide is brought into a water solution having magnesium hydroxide and calcium hydroxide, so as to convert them into magnesium carbonate and calcium carbonate; the reaction has chemical reaction formulas shown below:

Mg(OH)₂+CO₂→MgCO₃+H₂O

Ca(OH)₂+CO₂→CaCO₃+H₂O

The above-mentioned reaction not only captures carbon dioxide, but also converts it into magnesium carbonate and calcium carbonate. In other words, the method can use the industrially produced waste products (brines resulted from seawater desalination) or by-products (sodium hydroxide resulted from the making of chlorine) for the capture of carbon dioxide, and the overall chemical reaction thereof is fast (in comparison with the current physical or biological methods), which effectively reduces the overall costs of the method.

According to the invention, the final products resulted from the method for capturing carbon dioxide are: calcium carbonate, which can be utilized in the making of fireproof building materials and paints, as well as in steel-making and the production of high molecular materials and paper-making; magnesium carbonate, which can be applied in flooring, fireproof and fire-fighting products, cosmetics, facial powder and toothpaste, as filling materials, in plastic products for suppressing smoke from occurring, into neoprene rubber to be used as a desiccant, as intestinal laxatives, and food color preservatives.

An experiment according to the invention has been described below, which is not to be used to limit the scope of the invention; any obviously reasonable modifications thereof can be carried out by those skilled in the arts of this field without departing from the scope of the invention.

### EXAMPLES

### Example 1

(1) The Preparation of sodium hydroxide (NaOH):

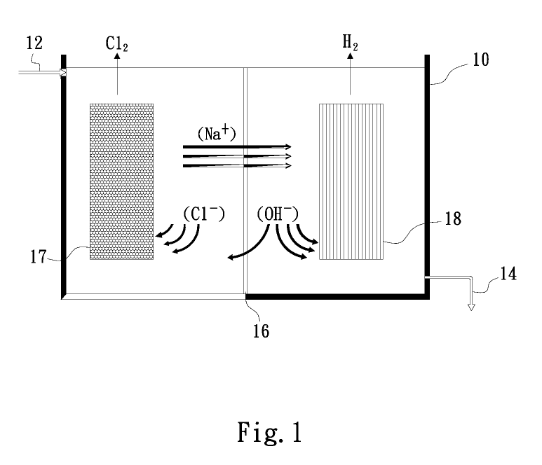

As shown in FIG. 1, a saturated salt solution or brine was continuously brought into an electrolytic tank in order to allow the electrolytic reaction to continue, and to obtain a solution of sodium hydroxide (NaOH) consistently; wherein a stable electric current of 40 Ampere (A) was set up in an electrolytic tank 10, and an electric potential thereof was set at greater than 1.5 Volt (V). In addition, an ion-exchange membrane 16 was set at the center of the electrolytic tank 10, while brine was brought into an inlet 12, and the brine was allowed to flow through the electrolytic tank 10; an anode 17 of the electrolytic tank 10 underwent a reaction of: 2Cl⁻→Cl₂+2e⁻, in which chlorine gas resulted from electrolysis was released from the anode, whereas a cathode 18 of the electrolytic tank 10 underwent a reaction of: 2H₂O+2e⁻→2OH⁻+H₂, in which hydrogen gas resulted from electrolysis was released from the cathode. Moreover, sodium ions (Na⁺) and hydroxide ions (OH⁻) in the solution subsequently combined to form sodium hydroxide therein (NaOH_{(aq)}), which then exited from an outlet 14. By allowing the electrolysis reaction to run for 24 hours continuously, an average of 58 g of sodium hydroxide could be obtained for each hour.

(2) The Preparation of magnesium hydroxide and calcium hydroxide, and the Capture of carbon dioxide:

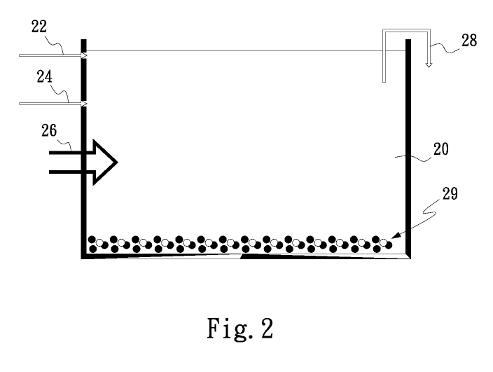

As indicated in FIG. 2, a reaction tank 20 had a seawater inlet 22 for allowing seawater to flow thereinto, a sodium hydroxide inlet 24 for allowing the sodium hydroxide obtained in the previous step to flow thereinto, and a carbon dioxide inlet 26 for allowing carbon dioxide to flow thereinto, so as to allow the reactants including seawater, sodium hydroxide, and carbon dioxide to react with each other in the reaction tank 20. The reactions resulted in a precipitation 29 of magnesium carbonate/calcium carbonate, which precipitated at the bottom of the reaction tank 20, and the seawater that had undergone the reaction was allowed to exit from the reaction waste outlet 28; the aforesaid reactions could be indicated in the following chemical reaction formulas:

MgCl₂+2NaOH→Mg(OH)₂+2NaCl

Mg(OH)₂+CO₂→MgCO₃+H₂O

CaCl₂+2NaOH→Ca(OH)₂+2NaCl

Ca(OH)₂+CO₂→CaCO₃+H₂O

In the aforesaid reactions, magnesium chloride reacted with sodium hydroxide to form magnesium hydroxide, and the magnesium hydroxide further reacted with the carbon dioxide that flowed into the tank to form magnesium carbonate, which precipitated at the bottom of the reaction tank 20; whereas calcium chloride also reacted with sodium hydroxide to form calcium hydroxide, and the calcium hydroxide further reacted with the carbon dioxide that flowed into the tank to form calcium carbonate, which also precipitated at the bottom of the reaction tank 20.

In the aforesaid equipment, an average of 445.9 g of magnesium carbonate and 92.3 g of calcium carbonate could be obtained after adding 90 g of sodium hydroxide and carbon dioxide that had undergone sufficient exposure into one kilogram of seawater. After conversion, it showed that by adding 90 g of sodium hydroxide into one kilogram of seawater, an average of 277 g of carbon dioxide could be captured.

(3) Estimating Costs for the Method for Capturing carbon dioxide:

The aforesaid conversion indicated that by adding 90 g of sodium hydroxide into one kilogram of seawater, an average of 277 g of carbon dioxide could be captured, hence costs for capturing one metric ton of carbon dioxide were shown in Table 2 below:

TABLE 2
Estimating costs for processing one metric ton of carbon
dioxide.

| Items | Costs |
|---|---|
| Electricity | approx. USD $31.511 |
| Equipment | approx. USD $5.351 |
| Operations | approx. USD $1.338 |
| Materials | approx. USD $23.438 |
| Others | approx. USD $1.000 |
| Total | approx. USD $62.638 |

It is estimated that for capturing every metric ton of carbon dioxide, it requires USD $62.638 in costs, which is close to the cost of USD $50-100 for capturing every metric ton of carbon dioxide by using geologic storage. However, the method for capturing carbon dioxide of the invention has advantages including: A. It employs chemical reactions for carbon dioxide storage, which is faster than the method of physical storage; B. It employs chemical reactions for carbon dioxide storage, which is more stable and safer than the method of physical storage; C. The storage by using the method bears lesser impacts to the environment; D. It does not require further costs for future monitoring activities as demanded for the method of physical storage; E. The costs for materials could be further reduced when the method is applied on a large scale; F. The use of the method results in final products that have added values.

The invention has been described with a preferred embodiment thereof, and it should be understood by those skilled in the arts of this field that the embodiment can only be used to illustrate the invention, not to limit the scope of the invention. It should be noted that equivalent changes and substitutions to the described embodiment can be carried out without departing from the scope of the invention. Therefore, the scope of the invention is intended to be limited only by the appended claims.

What is claimed is:

1. A method for capturing carbon dioxide, comprising the steps of:
(1) electrolyzing a saturated salt solution so as to obtain sodium hydroxide, which has a chemical reaction formula of:
2NaCl+2H₂O→2NaOH+Cl₂+H₂;
(2) adding the sodium hydroxide into a seawater solution, so as to allow magnesium chloride and calcium chloride in the seawater to be converted into magnesium hydroxide and calcium hydroxide, which has chemical reaction formulas of:
MgCl₂+2NaOH→Mg(OH)₂+2NaCl;
CaCl₂+2NaOH→Ca(OH)₂+2NaCl;
(3) bringing carbon dioxide into a water solution having magnesium hydroxide and calcium hydroxide, so as to convert the magnesium hydroxide and calcium hydroxide into magnesium carbonate and calcium carbonate, which has chemical reaction formulas of:
Mg(OH)₂+CO₂→MgCO₃+H₂O
Ca(OH)₂+CO₂→CaCO₃+H₂O.

2. The method of claim 1, wherein the saturated salt solution used in the step (1) is a brine having high concentration of salt.

3. The method of claim 2, wherein the brine is a waste product resulted from seawater desalination.

4. The method of claim 1, wherein the sodium hydroxide of the step (1) is a by-product of chlorine gas resulted from electrolyzing a saturated salt solution.
